(19) United States
(12) Patent Application Publication
(10) Pub. No.: US 2015/0066732 A1
(43) Pub. Date: Mar. 5, 2015

(54) SYSTEM AND METHOD OF RECONCILIATION OF TRADE, PAYMENT AND DELIVERY DATE WITH EXPECTED TRANSACTIONS

(71) Applicant: ACCOUNTREX LTD., Beit Shemesh (IL)

(72) Inventor: Stephen ESCOTT, Bet Shemesh (IL)

(21) Appl. No.: 14/534,271

(22) Filed: Nov. 6, 2014

Related U.S. Application Data
(63) Continuation-in-part of application No. 14/059,488, filed on Oct. 22, 2013.
(60) Provisional application No. 61/716,629, filed on Oct. 22, 2012.

(51) Int. Cl. G06Q 40/04

(52) U.S. Cl. CPC G06Q 40/04
USPC 705/37

(57) ABSTRACT

A system, method and graphical presentation method of reconciling trade, delivery and payment records of financial transactions by grouping records on the basis of the offerings or transactions to which such records relate, matching buy and sell records for securities in the offering, pairing delivery and receipt records of such securities into various accounts, and pairing wire funds transfers. Grouped, matched and paired records are loaded into a ledger where calculations are executed and presented to show open and closed positions, delivered and received securities and wire transfers.

### CROSS REFERENCE TO RELATED APPLICATIONS

This application is a continuation in part of U.S. patent application Ser. No. 14/059,488, filed on Oct. 22, 2013, and entitled “Multi-Brokerage Account Management System”, which claimed priority from U.S. Provisional Patent Application No. 61/716,629, filed on Oct. 22, 2012, and from U.S. Provisional Patent Application No. 61/832,992, filed on Jun. 10, 2013, all of which are incorporated herein in their entirety. This application claims priority to an application filed before Mar. 16, 2013, and contains one or more claims not entitled to a filing date before Mar. 16, 2013.

### FIELD OF THE INVENTION

The present invention relates generally to reconciliation of financial accounts and in particular to reconciliation of financial trading transactions and presentation of financial positions across numerous financial accounts.

### BACKGROUND OF THE INVENTION

Syndicate traders may include private asset managers that purchase and often immediately sell shares of initial public offerings of securities (IPO), secondary public offerings of (SPO) other public offerings of securities.

Syndicate traders may manage funds in multiple accounts, often owned by multiple tax entities. Separate accounts may be needed at the different underwriting firms involved in a stock offering in order to facilitate the purchase of as many shares as possible at the subscription price. At each underwriting firm, a trader may manage separate accounts for multiple tax entities, representing different investors or partnerships. Additionally, shares are often sold in accounts other than the ones that they were bought in, necessitating the delivery of the shares from “purchase” accounts to “sale” accounts.

Maintaining multiple tax entities and their multiple accounts leads to difficulty in the management of cash flow, as well as securities deliveries and money transfers. These factors create operational complications, and can make cash availability estimates impossible due to erratic delivery and transfer behavior, leading to less profitable trade execution and settlement failures.

Many investment funds purchase shares on a “delivery versus payment” (DVP) basis, which is an automatic settlement process, flowing through a central “Prime Brokerage” account. The Prime Broker centralizes the firm's funds, and electronically delivers and receives stock versus automatic money transfer to and from the DVP brokerage accounts at other brokerage firms that are involved in that fund's trades. Some smaller trading funds do not operate via DVP, as capital requirements for the maintenance of a Prime Broker account are very high. They use regular “Cash” accounts—funded by check or regular money wires, and not via DVP. Cash accounts are maintained by some larger funds as well. Since new and secondary offerings are not always available via DVP, as underwriting firms try to limit access to certain deals to smaller investors, it becomes necessary for both large and small funds to transact these deals on a cash (non-DVP) basis, involving manually initiated money wires and stock deliveries.

### SUMMARY OF THE INVENTION

Some embodiments of the invention may include a method for reconciling trade, payment and delivery data in a plurality of financial accounts. An embodiment may include receiving into a memory device or storing data from numerous securities transaction records from numerous financial accounts from various securities offerings. An embodiment may associate or group each, some or all of the stored records with one or more securities offerings by grouping the individual records under an issuer identifier of the offering that may include or be associated with an issuer identifier of the offering and proximity of a date of the offering. A transaction records with a different issuer symbol or widely different date that a first offering may be grouped with a second or different offering.

An embodiment may compare a quantity of securities in buy transaction records that are grouped with a first offering to a quantity of securities in sell transactions records that are grouped with the same offering, and such comparison may be made across various accounts from various entities with various brokers. An indication of an open position may be issued to a user if the comparison indicates a difference in the quantity of securities in the buy transaction records as compared to the sell transaction records. A number of securities represented by the open position, the account wherein the open position is held, and the financial implications or balance of the open position may be reflected or displayed for a user in association with the relevant record, relevant account or relevant offering.

Embodiments may compare an account identity of a buy transaction record to an account identity of a sell transaction records, and if the account identities are not the same, a data field may be opened for a delivery and receive record of a quantity of securities of the buy transaction record and the sell transaction records. A search may be made for the delivery and receive transaction records, and they may be paired to indicate that requisite shares were moved from the buying account to the selling account. A signal or alert may be issued if there is at least one of a delivery and receive record from the accounts relating to the offering that are not paired, to indicate that securities were not sent or received.

In some embodiments, transaction records of funds deliveries and receipts that were downloaded and stored in a memory may be paired to show which wire send record reflects its counterparty wire received record. A signal or alert may be issued if there is a funds delivery funds received record for an offering, entity or account that is not paired. An alert or other signal may be issued and presented to a user that may include a date upon which the quantity of securities is due for deposit in the relevant account

In some embodiments, the records that are downloaded from on-line brokers may be stored in a first database or memory, and the process of grouping, pairing, and matching the records may be executed upon the entry of such records into a second table or ledger. The calculations of paired transactions, received and delivered transactions, open positions, unfunded accounts and the like may be reflected in the ledger.

Some embodiments of the invention may include a method of displaying financial transactions that arise from or relate to various accounts, offerings and entities by graphically representing, along a first axis of a display, a buy transaction of securities of a first offering, and along a second axis of the display a sell transaction of securities of the offering. The display may present or show, as associating with the graphical representation of the buy transaction, one or more of a number of securities bought in the buy transaction, and an issuer identifier of the securities and amount of money owing from the buy. The display may represent or show, as associating with the graphical representation of sell transaction, a number of securities of sell transaction, an issuer identifier of the securities and an amount of money to be received from the sell. A graphic presentation on another axis of the display may be made of a connection between the represented buy transaction to represented delivery of securities purchased in buy transaction, and representing along the axis of the display of a connection of the sell transaction to a graphical representation of a receipt of securities sold in the sell transaction.

A graphic display may be made of a pairing of a transaction record of the delivery of securities with the receipt of securities and a connection of the delivery to the receipt.

One or more of the displayed buy and sell transactions may show an amount of money to be delivered or received in connection with the buy and the sell transactions respectively, an amount of money to be received in or sent to an account wherein the buy or sell transactions were executed, and an indication of an account where there may be held insufficient monies to cover an amount owing to be paid from a financial account wherein was executed a buy transaction. A graphic representation of a flow of money in one or more wire transfers between one or more accounts may be shown as connected to such accounts and related transaction records. The display may present a visible signal of an open position associated with at least one of the buy transactions, sell transaction or accounts and an amount of money represented by such open position or as is available in such or other accounts.

Some embodiments of the invention may include a system to associate, match and pair financial transaction records, where the system includes a processor, a memory and a display. A memory may store in a first data structure transaction records from financial accounts, and in a second data structure financial transaction records that have been grouped, matched and paired. In some embodiments, the processor may associate the financial transaction records with a unique identifier of an offering by comparing a date and issuer symbol of the offering with a date and issuer symbol of each, some or all of the financial transactions. A processor may match buy transaction records of the offering with sell transaction records of the offering. A processor may issue an alert if a number of securities bought in buy transaction records is not equal to a number of securities sold in sell transaction records. A processor may pair a delivery transaction record associated with the offering to receive transaction records associated the offering, and issue an alert if at least one delivery transactions is not paired to at least receive transaction records. A processor may pair each of funds deliver record in the financial transaction records with at least one funds receive record in the financial transaction records, and issue an alert if at least one funds deliver records is not paired with at least one funds receive record. A processor may issue a signal to store the matched and paired records in a ledger or data structure. A processor may issue an alert if a funds balance in at least one account is insufficient to cover a stun of money required to cover an obligation of a buy transaction record; and issue a signal if first delivery transaction record is not paired with a receive transaction record.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a schematic diagram of components of a system in accordance with an embodiment of the invention;

FIG. 2 is a schematic diagram of an allocation blotter in accordance with an embodiment of the invention;

FIG. 3 is a schematic diagram of trade blotter in accordance with an embodiment of the invention;

FIG. 4 is a schematic diagram of ledger in accordance with an embodiment of the invention;

FIG. 5 is a schematic diagram of a transaction download table in accordance with an embodiment of the invention;

FIG. 6 is a schematic diagram of an open position table in accordance with an embodiment of the invention;

FIG. 7A is a schematic diagram of an undelivered positions table in accordance with an embodiment of the invention;

FIG. 7B is a schematic diagram of an account balances table in accordance with an embodiment of the invention;

FIG. 8 is a flow diagram of a method in accordance with an embodiment of the invention;

FIG. 9 is a flow diagram of a method in accordance with an embodiment of the invention; and

FIG. 10 is a schematic presentation of a display of transactions in accordance with an embodiment of the invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

When used in this application and in addition to its regular meaning, the term ‘offering’ or ‘deal’ may refer to an issuance of one or a related securities, such as shares, bonds, options, calls, puts, indexes or convertible instruments, by one or a related group of entities in one or a group of related accounts. Non-limiting examples of offerings and deals may include an IPO, an SPO, or another group of related purchases and sales of securities that may be executed by one or a group of related traders as part of a strategy or series of purchases and sales of securities. Purchases of securities in an offering or deal may be made from an issuing company, from an underwriter, from another trader or from other market participants. In some embodiments, two separate deals may be undertaken in a single security, and such deals may be differentiated by any of a time or duration of a first deal and a time or duration of a second deal, a strategy of a first deal and of a second deal, a purchasing or selling entity or account of a first deal and of a second deal, or other differentiating factors.

When used in this application, the term ‘securities account’ or ‘financial account’ may, in addition to its regular meaning, mean any account, asset or liability listing or other numbered or uniquely identified indication of an association of assets, liabilities, funds, balances, debits, credits or securities. An account may include a brokerage, bank, stock, securities, money market, mutual or other repository of records of financial rights or claims of one party or entity on another.

When used in this application, the term ‘matching’ may in addition to its regular meaning, imply that there is a basis upon which to associate first record with a second record. By way of example, a funds delivered transaction record may indicate that an amount of $1000 was delivered on January 2. A funds received transaction record may indicate that an amount of $980 was received on January 4. The similarity of the sums that were delivered and received and the proximity of their dates may be grounds upon which a match between the two records may be made, where the differences in sums and dates may be accounted for by fees and net payments amounts, and a difference in dates may be accounted for by lags in execution of transactions. Tolerances levels of differences that may be ignored for matching purposes may be set by for example a user or dynamically as part of an attempt to account for non-matched sums. Matching of security symbols that are not identical may also be enabled to allow for matching of for example a security and an option or convertible instrument to purchase the security, or a security purchased or sold as a hedge or cover on another security purchased or sold.

When used in this application, the term or phrase ‘receiving into a memory device’ may in addition to its regular meaning include storing digital signals of for example a record of a financial transaction in one or more organized and retrievable data structures such as a table, data base or other accessible format.

When used in this application, the term ‘alert’ signal, in addition to its regular meaning, may include a textual, visual, auditory or other indication of an existence of a condition. In some embodiments, such an alert may be presented to a user by a color of an entry or mark on a screen, by a specific font, bold or other mark designed to indicate or call to the attention of a user of such condition.

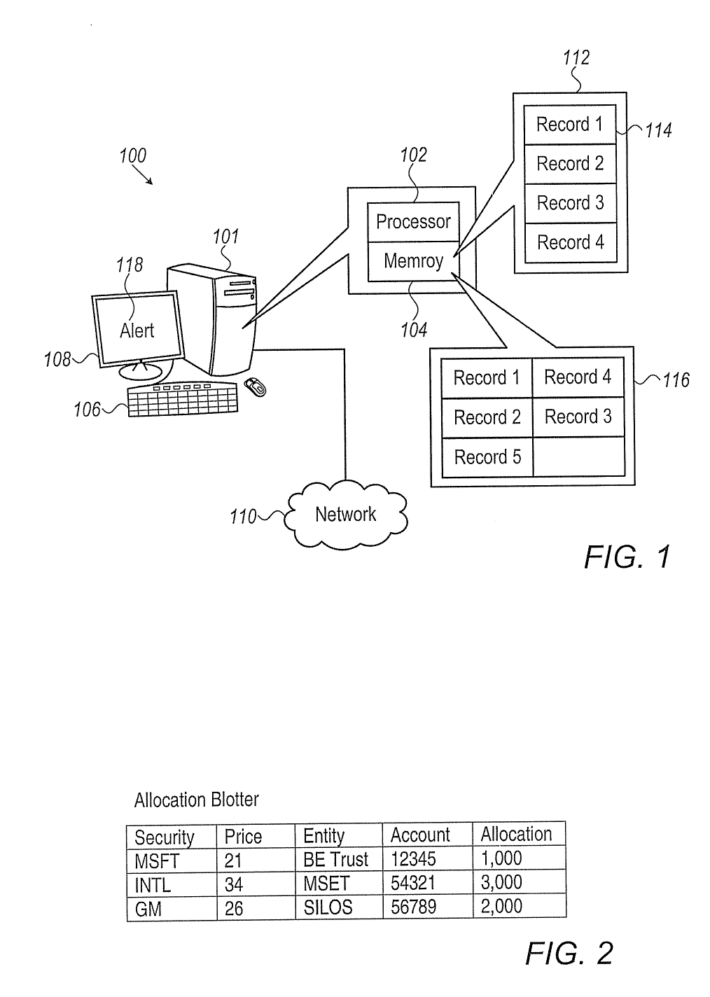

Reference is made to FIG. 1, a schematic diagram of components of a system 100 in accordance with an embodiment of the invention. System 100 may include one or more computing devices 101 having one or more processors 102, one or more memory 104 units, one more input devices 106 such as keyboards, touch screens, microphones or other input devices, one or more output devices 108 such as display screens, one or more communication mediums such as wired or wireless networks 110. In some embodiments, one or more of such processors 102, memory 104, input devices 106, output devices 108 and network 110 connections may be located remotely from each other. One or more tasks or functions of such one or more devices may be accomplished or executed by one or more units or devices. Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 104, computer-executable instructions such as executable code and a processor such as processor 102 may execute such code.

Processor 102 may include component's such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a tablet computer, a network device, or any other suitable computing device. Unless explicitly stated, the method embodiments described herein are not constrained to a particular order or sequence. Additionally, some of the described method embodiments or elements thereof can occur or be performed at the same point in time. It will be recognized that any suitable number of input devices may be operatively connected to processor 102.

Memory 104 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. In an embodiment, memory 104 is a non-transitory processor-readable storage medium that stores instructions and the instructions are executed by processor 102. Memory 104 may be or may include a plurality of possibly different memory units.

Memory 104 may store executable code which may be any executable code, e.g., an application, a program, a process, task or script. Executable code may be executed by controller 102, where executable code may carry out operations described herein in real-time.

In some embodiments, more than one computing device 101 may be used in place of a single computing device 101. For example, a plurality of computing devices that include components similar to those included in computing device 101 may be connected to a network and used as a system, for example a distributed system.

Input devices 106 may be or may include a mouse, a keyboard, a touch screen or pad or any suitable input device. It will be recognized that any suitable number of input devices may be operatively connected to processor 102 and memory 104.

Output devices 108 may include one or more displays, speakers and/or any other suitable output devices. It will be recognized that any suitable number of output devices may be operatively connected to computing device or processor 102.

In some embodiments, system 100 may associate, match and pair financial transaction records. Memory 104 may in a first data structure 112 such as a data base or list of records 114, two or more financial transaction records 114 of two or more financial accounts, and may store in a second data structure 116 such as another data base, one or more of the financial transaction records that have been matched and paired with other financial transaction records 114. In some embodiments, processor 102 may associate two or more of the downloaded or stored financial transaction records in the first data base or data structure 112 with a unique identifier of an offering of securities. A process of such association may include or be accompanied by for example comparing a date and issuer symbol of an offering with a date and issuer symbol the respective financial transactions. Processor 102 may match buy transaction records associated with the offering to sell transaction records associated with the offering, and may signal or issue an alert on output device 108 if a number or sum of the securities bought in the buy transaction records is not equal to a number or sum of those same securities sold in the sell transaction records.

In some embodiments, processor 102 may pair securities delivery transaction records 114 associated with the offering to two or more of receive transaction records associated with the offering, and may issue a signal to display an alert 118 on output device 108 if at least one of the delivery transactions is not paired to at least one of the receive transaction records. An alert may also be generated if one or more of a deliver or receive record is not downloaded by a date that a required delivery date. Processor 102 may pair funds delivery records from among the stored the financial transaction records 114 with one or more funds receive records from among the stored financial transaction records 114, and may issue a signal to display an alert 118 if at least one of the funds deliver records is not paired with at least one of the funds receive records. In some embodiments, processor 102 may issue a signal to store the matched and paired records in second data structure 116, such as a ledger.

In some embodiments, processor 102 may issue an alert if a funds balance in an account is insufficient to cover a sum of money required to meet an obligation of at least one of the buy transaction records, at or before a time when such obligation matures or settles.

In some embodiments, processor 102 may issue a signal to show a representation of a first of the accounts that is associated with the delivery transaction record, and a second of the accounts that is associated with the receive transaction record.

In some embodiments, processor 102 may issue a signal to show a representation of the pairing of a first of the accounts and a second of the accounts, upon a delivery transaction record being paired or associated with a receive transaction record.

Reference is made to FIG. 2, is a schematic diagram of an allocation blotter in accordance with an embodiment of the invention. A user may log or record share buy transaction records 202, subscriptions, allocations, sales and money transfers as they happen or at some other time in what may be called a note pad or blotter 200. Blotter 200 may be or include one or more data structures such as a table, data base or other collection or records. In some embodiments, a blotter 200 may be or include an electronic spreadsheet or database wherein data about transactions may be stored and recorded. For example, in an allocations blotter 200, offering allocations, or the number of shares that the user has subscribed for, may expect to receive or is obligated to purchase in an offering may be recorded. Allocations may be recorded by one or more of deal, offering, managed entity (such as the name or title of a company, partnership or person for whom the allocation, sale, purchase or other transaction is being executed), and by clearance method, such as free delivery allocations, DVP allocations, self clearing (not for delivery) allocations, or others. The transaction data that is stored on blotter 200 may later be used to match transaction data that is downloaded from a broker of on-line source that reports executed transactions.

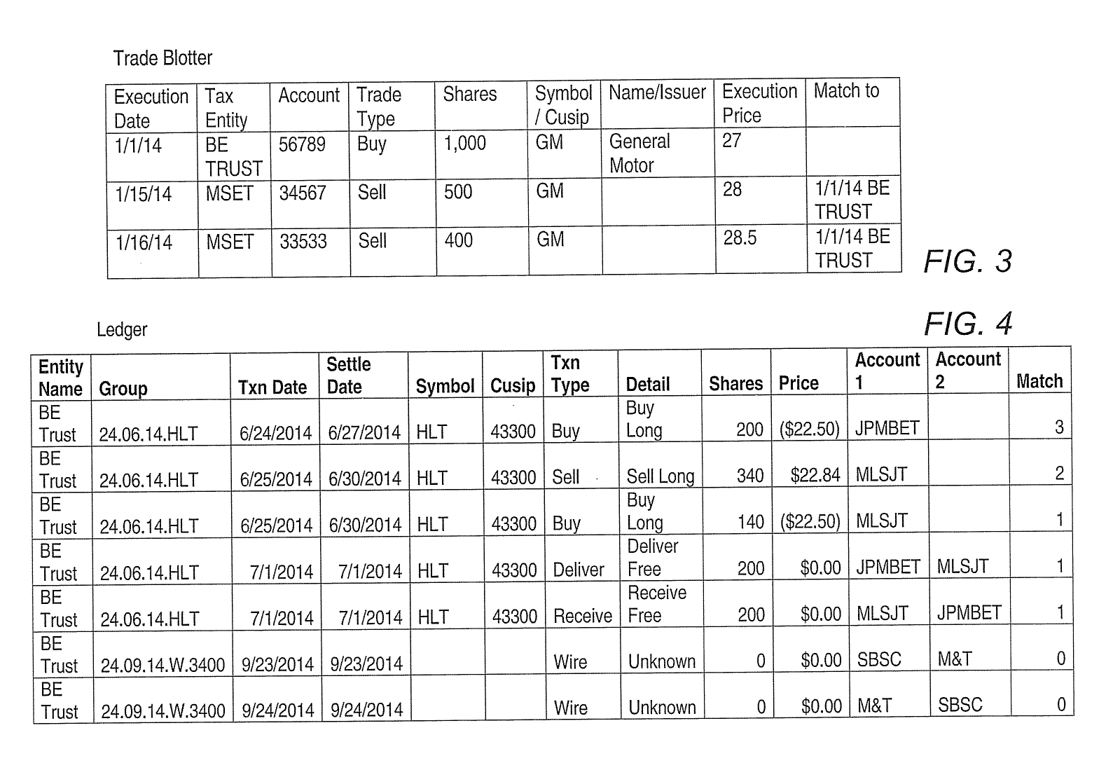

Reference is made to FIG. 3, a schematic diagram of trade blotter in accordance with an embodiment of the invention. A second or continued blotter may include a trade blotter 300 where or onto which a user may enter matched shares that are for example sold with lots of sales that had been purchased or allocated to the trader in a same or different account 302, and may indicate the account or entity 304 from which the security is to be delivered. A matching of a buy to a sale may take place whether the shares exist in the allocations blotter 200, because for example the shares were purchased on a stock offering, or because for example they were bought in a regular open market transaction.

Reference is made to FIG. 4, a representation of a ledger 400 or data base wherein there may be recorded and shown matched or paired financial transaction records. A matching of a buy transaction record 402 to a sell transaction record 404 may be done in a ledger 400, which may include a transaction database compiled from confirmed transaction downloads via the trader's brokerage accounts. Such matching of purchases and sales of shares may preferably be done on one or more blotters to increase the accuracy of the automatic trade matching that occurs when the transactions are downloaded from the on-line brokerage reports.

In some embodiments, transactions may be downloaded automatically from on-line brokerage account reports into, for example, a download screen, which may then be accepted into the ledger. Reports of sales and purchases that are not downloaded may be manually entered into the ledger.

Some or all transactions, trades, stock deliveries or stock receipts may be grouped into one or more transaction groups 406 deals or offerings within for example a blotter or ledger. The group, such as a particular offering, deal or strategy, such as the offering, purchase and sale of shares and options of a company, may be assigned a unique identifier, such as for example 24.06.14.HLT, which may become the group 406 or offering identifier. During or after acceptance of financial transaction records into a ledger 400, transactions within a transaction group that are specifically affiliated with each other, such as a sale and purchase of certain specific buy lots, or a delivery and receipt of certain bought shares or money transfer, may be further matched or paired to their source or counterparty transactions. Such matching may include, for example, the matching of a sale in a transaction group to a buy lot of securities in such transaction group, or the delivery or shares in a transaction group to the receipt of such shares. Such grouping, matching and pairing may be executed automatically, as is described below or manually by a trader or other user.

Grouping of transactions and associating purchases, sales, receipts and deliveries within a unique group may allow linking of trades that are relevant to a particular trading or hedging strategy to produce a single profit/loss figure, even if those trades have taken place with different securities issuers, security types (such as stocks and their affiliated options), at different times, in different accounts or at different firms.

Transactions that are accepted into a ledger, may also be grouped for inclusion in filtered profit/loss reports and may be tagged or have text, colors, icons or comments linked to the transaction to allow showing performance of transactions bearing a given tag or icon. For example, if trades or more trades are tagged as belonging to a particular trader, such trader's performance can be rapidly analyzed by generating a profit/loss report filtered by his tag.

Ledger transaction data may be analyzed via tables, graphs and alerts on a dashboard or other display format. Such a dashboard or display may allow monitoring of portfolio holdings, stock delivery, money balances and other real time or historic data. A dashboard may also aggregate and show alerts such as open positions, underfunded accounts, missed deliveries and other events. In some embodiments, a method may forecast an entity's or account's cash position by simulating upcoming trade settlement and delivery using that account's historical stock delivery speed. Such delivery speed may be entered or collected automatically based on average historical delivery time or other factors. Cash availability for an account or entity across all of that entity's accounts may be predicted to allow a user to subscribe to future securities offerings with an accurate idea as to how many shares or deals at a time the available funds may handle.

A dashboard may present data for multiple entities and multiple accounts. Data may be viewed via an “Entity” tab, or a summary of client data via an “All Entities” tab.

An analysis of a typical or example of a transaction illustrates how the ledger works together with the blotters and the dashboard.

A free-delivery transaction may, in some embodiments, proceed as follows:

A security called MSFT may announce a secondary public offering. It happens to be that 4000 Shares of MSFT were previously purchased and have been in the user's portfolio for 6 months before this secondary offering was announced. Those shares appear as an open position in the dashboard's open positions list. Even so, the user may study the deal and decide that additional shares should be acquired in the offering, and then resold soon after.

Information about the offering may be downloaded or otherwise entered into the blotter, and the user may select the new MSFT deal for addition to the allocations blotter.

A list may be manually or automatically generated in the allocations blotter, providing spaces into which a user may enter indications (subscriptions) and allocations of shares for the MSFT deal. A line may be generated for one or more accounts that the user has at underwriting firms selling shares on the deal to indicate the possibility that the user will receive allocations of shares of the deal into such accounts.

The user may call his brokers to order shares of the MSFT deal, and may enter an indication amount of the maximum allocation that he may receive for the deal in the cell of the indications column for the relevant account name.

The deal may be priced at for example $29 per share. On the day of the pricing, the user calls his brokers to find out the number of shares allocated to him, his entities or his accounts. The allocation blotter may then be updated with the number of shares allocated for each account.

The user may have received an assortment of allocations from different brokers and in different accounts, totaling 4000 shares of MSFT through the secondary offering, as follows: 1200 from UBS or other broker/underwriter, 1150 from JPM, 500 from RBC, 650 from MS and 500 from WF. The user then owns a total of 8000 shares: 4000 purchased at the offering price and 4000 shares that have been owned since before the offering.

On the day of the secondary offering, the user observes the price movements of the stock, and decides that it is time to sell some to his account UBS. In an example, the user sells what he received on the stock offering, as well as 500 of the shares in his prior position, while leaving 3500 in his portfolio. The order is given to sell 4500 shares at $29.50.

The user may open the blotter screen, and enter the following order information into the trade blotter: Sell 4500 shares of MSFT at $29.50 per share, and the broker calls back to inform the user that in fact the trade executed at the $29.50 price.

The user selects the relevant order in the trade blotter, and enters the execution price into the execution price cell.

The user may execute a match-trades function to allow him to record which owned lots of MSFT were sold at this time, whether the lots are from the newly allocated shares, from other shares bought and entered into the trade blotter, or from the older shares that were in the ledger. Once the shares to be matched are indicated, the information on the matched sold, bought and held shares may appear in the trade blotter.

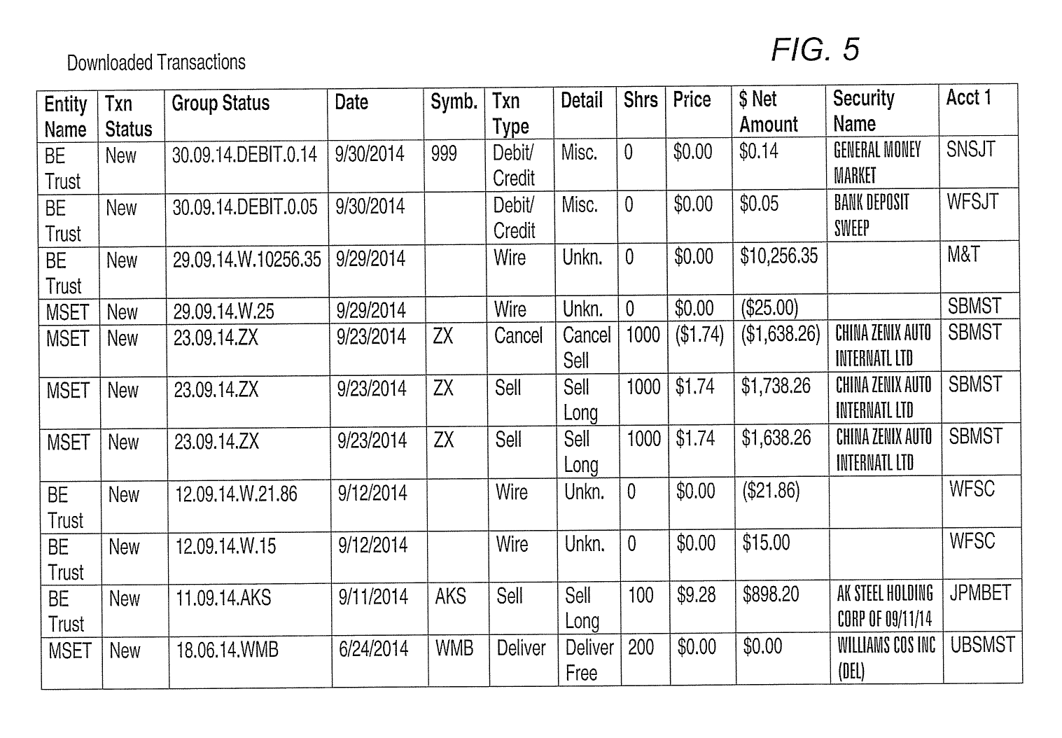

Reference is made to FIG. 5, a sample table of downloaded financial transaction records in accordance with an embodiment of the invention. Trade data and records may be downloaded from an on-line brokerage account, and transaction data records may be received confirming the previous day's trades, including the MSFT allocations of 4000 shares and the sale trade of 4500 shares, stock and money transfers, or any other fees or credits. Transaction confirmation data may also be manually entered.

The downloaded or entered transactions may be grouped by, for example, stock symbol, date proximity with the date of the offering, or with other factors that may associate a downloaded transaction record with a group. The unique identifier may be associated with the grouped transaction.

Based on the trade matching that may have been entered into the trade blotter or calculations of matching patterns, a determination may be made that the new MSFT sale trade is relevant to both the more recently purchased shares, as well as 500 of the shares purchased at a much earlier date. The sale will be split automatically between the two transaction groups (the current offering and the prior position of shares) based on the user's input, as was entered into the trade blotter. Alternatively, if the downloaded sale data is accepted manually, the trader can manually split the sale, regardless of whether or not the trades were matched beforehand.

Downloaded data may include stock trades and deliveries, as well as money transfers that took place in the user's accounts on a previous day. The newly downloaded trades may be downloaded by the user into the transaction database.

For the sale of MSFT that is relevant to two transaction groups, i.e., the current′ offering and the user's existing open position, the user selects the transaction groups that are relevant to the sale, as well as the share lots within those groups that were sold. The sale is accepted into the ledger as a split transaction.

In some embodiments, one or more rules may be applied as a criteria for accepting one or more transactions into a ledger. An example of such a rule may be that if there is a sale in the blotter that has been matched to a buy or allocation in the ledger or blotter, and a sale has been downloaded that is the same as the sale in the blotter (based on shares, account, symbol, price, date or other indication), and, if the blotter sale is matched to a buy in the ledger, or to a buy/allocation in the blotter that has later been downloaded and accepted into the ledger, then accept the sale and match it to the buy in the ledger. If no blotter match has been found, and there is an open position in the ledger for a certain security in a certain account, accept any sale of that security in that account that is for less than or equal to the number of open shares, and match it to the buy.

In some embodiments, one or more of the downloaded transaction may be automatically matched, by comparing the downloaded data with information that has already been entered into the blotters and entering into the ledger those downloaded transaction records that match the blotter records. Receives and delivers of securities may be paired with counterparties (deliveries and receives from brokerage accounts) in addition to being matched with their affiliated securities transactions. The matched and paired transactions may be accepted into the ledger.

Once transactions have been accepted into the ledger, additional information may manually be added to transaction entries, such as notes, executing broker name, etc.

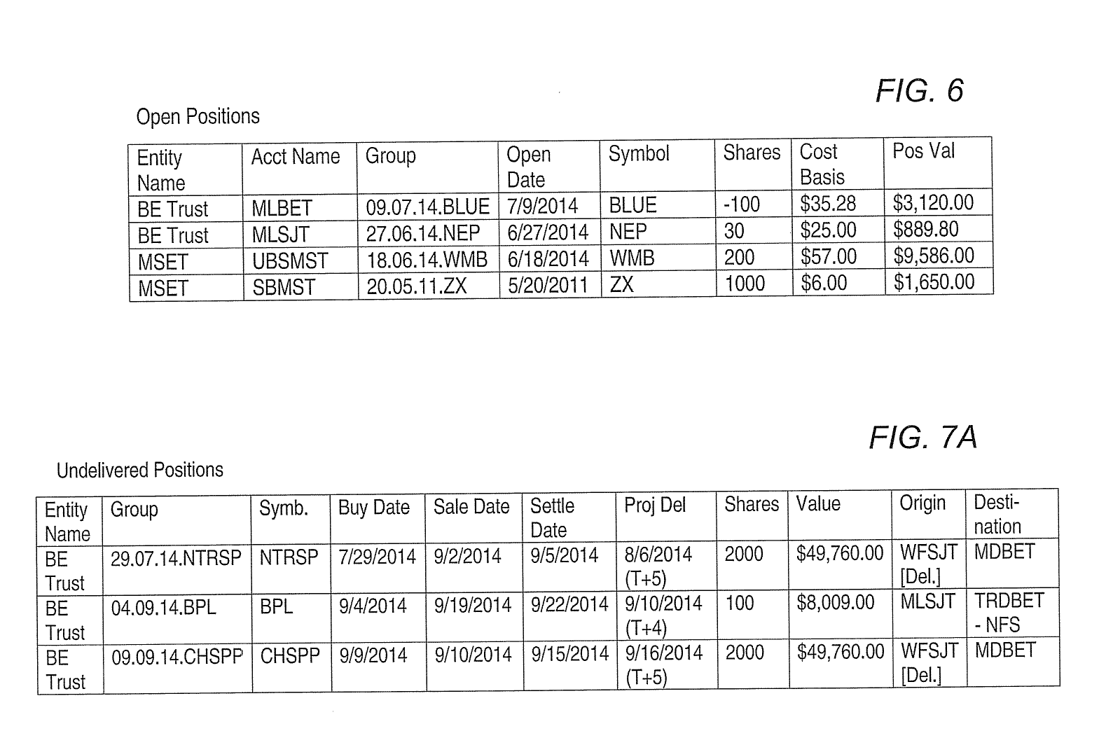

Reference is made to FIG. 6, a schematic representation of an open positions table, in accordance with an embodiment of the invention. An open positions line in the open positions table 600 may indicate that what was a 4000 share position of MSFT is now reduced to 3500 shares. An open position indication may show the original transaction group in which those shares were bought, with current price quote and position value.

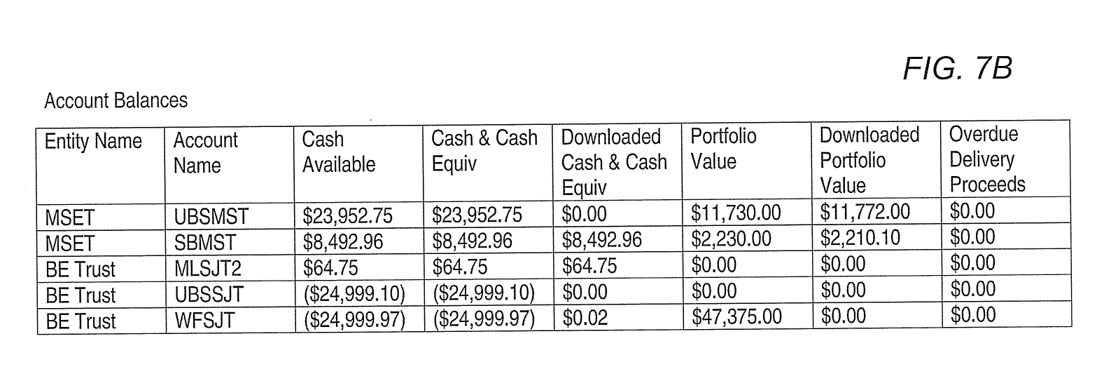

Reference is made to FIG. 7A, a schematic representation of an undelivered positions table 700 in accordance with an embodiment of the invention and to FIG. 7B, a schematic representation of an account balances table in accordance with an embodiment of the invention. The accepted information of a sale may generate a signal that a security delivery must occur to settle the trade, and an undelivered positions indicator may shows that 4500 shares of MSFT are not yet delivered from the accounts in which the shares were purchased, or received by Broker BS—the account the shares were sold to. Buy lots that have passed their projected delivery date (buy date+delivery speed in days) may show an alert that their delivery is delayed and may require follow-up.

A cash column for an account, as is shown in FIG. 7B, may reflect the changes in cash balance for one or more accounts. For example, for accounts in which the shares were bought, a cash balance may go down by the purchase price until settlement date—when the transaction is paid for, by either cash in the account or money transfer. In accounts at which the shares were sold, the cash balance may go down by the value of sale until the account/s receives the shares since the shares were sold in an account that did not yet hold the shares. In these cases, the brokerage firm reduces the cash availability of the account to represent the missing shares, until the shares are received into the account.

A balances indicator may show a cash level in one or more accounts. Further, a chart or table may be provided that projects cash availability in one or more account, by date or by a projected date. Until the accounts in which shares were bought have received money equal to the purchase amount, or the sale account “BS” has received the shares that were sold to it, cash availability will be lower. Once money has been received in the buy accounts, their balances rise accordingly. Likewise, when the shares have been received by “BS”, cash availability is replenished in that account by the amount of the sale proceeds, plus or minus any trade profit or loss.

For shares that have already been paid for, a user may request that a broker deliver those shares “Free” (since all payments have been received) out of an account and into another account at another firm, as long as the delivery takes place after settlement date—which is usually the third day after trade date (t+3). In practice, Free deliveries rarely occur on t+3, but rather can be delayed by days or weeks. A balances indication may display the user's projected cash availability based on historical brokerage account stock delivery or other factors that may be input by a user.

Until the buy accounts have been paid for the purchase of shares, or Broker BS has received its shares, alerts may be generated notifying the user that these actions still need to be done.

On settlement date, the user may be alerted to the fact that wire transfers have not yet been sent to the buy accounts in payment for the share purchases. On a following day, a further download is made of transaction data which includes the wire transfers from the sending and receiving broker accounts.

In the ledger, the sent and received wire transfers are paired into the same transaction group, and for each of the transactions the user selects the account into/from which the wire transfer is being sent. The sending account's balance drops by the amount of the wire transfer, while the receiving buy accounts' cash balances rises by the same amount. Since the user has now paid for the share purchase, the alerts for unpaid wire or money transfer to the broker are automatically dismissed from the message center.

After settlement date, until shares are delivered from broker ACTX to broker BS, the sale value of undelivered shares may appear in an overdue delivery position screen or other display, indicating the degree to which that account is straining the user's inter-account cash availability. At some future point, the shares are delivered from broker ACTX to broker BS.

A subsequent download of data may show the delivery of shares from broker ACTX and the receipt of shares by broker BS. Such delivery and receive transactions are automatically assigned Group ID numbers corresponding with the identified group. In this way, a delivery is grouped with its corresponding purchase lot by for example broker name, symbol, share amount, and blotter matching, where applicable. The delivery may also be automatically or manually matched with the related buy. If related receive transactions have been downloaded as well, they are grouped with related transactions, and matched with the related buy lot.

In some embodiments, one or more transactions that include two counterparties may be paired to each other, such as wire transfers that receive of deliver money, or such as securities transfers that receive or deliver securities.

Once the deliver and receive have been accepted into the ledger, the position may be automatically removed from the undelivered positions indicator. Similarly, a cash indicator in an account balances will reflect the changes in cash balance for each of the accounts. The overdue delivery balance for ACTX goes down by the sale value of the delivered shares. The cash balance for BS goes up by the value of the sale proceeds. Alerts relating to non-delivery of MSFT shares are automatically removed.

In some embodiments, transaction records sent from on-line broker systems may be downloaded for a user into a table such as a temporary downloads table. In some embodiments, one, some or all of the downloaded records may be assigned a group ID so that the record is associated with the offering or deals to which it is relevant. In some embodiments, the assignment of a group ID may rely or use a scanning of the user's ledger for transactions that took place within for example 30, 60 90 or more days of the date of the newly downloaded transaction, to find either the same ticker symbol or cusip (two types of identifying codes for US securities). If a same or similar symbol or CUSIP exists in the ledger, a new related transaction may be assumed to part of the same deal, and grouped together with the older transactions in the ledger by assigning the newly downloaded transactions the same group ID. In some embodiments, a group ID may use a dd.mm.yy.symbol format, though other formats may be used. If the underlying security of a newly downloaded transaction does not match recently or previously accepted groups in the ledger, or the older group has had at least 60 days of inactivity, the new transaction may be considered to be a new deal, and a new group ID may generated for the transaction. In some embodiments, a signal or query may be sent to the user to ask of the user wishes to open a new group ID or wishes to create a new Group ID or to attribute the unrecognized symbol or CUSIP with an existing group ID.

In some embodiments, one or more of the transaction records in a download table may be matched to one or more other transaction records by determining which downloaded and ledger transactions are the same as or refer to blotter transactions that a user may have already manually entered and matched to opposing transaction(s) as the trades were made. The blotter allows users to make note of their transactions as they happen, to ensure that transactions are carried out in an orderly fashion, not duplicated, and in order to compare to the broker confirmed downloaded transaction records. This information from the blotter may be used to augment automatic matching of downloaded transactions. For example, a buy transaction for 100 shares of MSFT may have been matched by a user in the blotter with a sell transaction of 300 shares of MSFT. A query by for example a search function may scan the blotter and the download transaction table for exact matches of account, symbol, cusip, shares, price, net trade money, or other variables that may associate transactions to each other. If an exact match is found, the transaction is recorded in the ledger. If an exact match is not found, one or more similar transaction records may be presented to a user with a query as to whether such similar transaction record is to be matched or paired with the subject record.

In some embodiments, relationships among transactions may be identified, assumed or predicted, and an embodiment of the system may inform the user of additional steps that need to occur, and an embodiment may recognize problems when additional downloads take place and either unexpected transactions are included or expected transactions are not included. For example, an initial buy transaction represents an open position that may be ready to be sold. Once a sell is matched to that buy, the system may mark the position as closed and no longer available for a future sale. If a sale took place in account 1234, and the buy was in account 5678, the system may recognize that the stock needs to be delivered from account 1234 to account 5678. An embodiment of the system may then automatically create at least one deliver and one receive data field that must be populated before the transaction can be changed from open to closed. An embodiment may scan downloaded transactions in the download for the expected delivery transaction in account 1234 and receive transaction in account 5678. If those transactions do not yet exist, the user may be notified that the delivery needs to take place. If the expected deliver and receive transactions are found in a download, and then accepted into the Ledger, they can be automatically matched to the created data fields, and the position may be moved from undelivered to delivered. If the receive and/or deliver transactions have not occurred by settlement date or within some other predicted time frame, the user may be alerted that something is wrong and that immediate action must be taken to expedite the delivery. Once a deliver and receive have been matched to a buy position, an embodiment of the system may determine that the shares necessary for the sale have been sent to the appropriate account, and the open data fields for the deliver and receive may be automatically removed from the user's display screen.

In a further example, when a buy or sell is canceled, and a cancel transaction is downloaded, the cancel must be matched to the transaction that it cancels so that it will be identified as not actually having taken place. A matching process may match the cancel to the appropriate buy or sell, and indicate that any opened fields for receive/deliver or payments for such cancelled orders are also to be cancelled and removed from a user's screen.

In a further example, a typical download of records may indicate that a delivery of securities has occurred from account 1234, but will not generally indicate where or to what account the shares were delivered. Similarly, a downloaded receive transaction will indicate that account 5678 has received shares, but will not indicated the account from which the shares were received. Returning to the example above, an embodiment of the invention may recognize that a buy of shares in account 5678 and a sale of shares in account 1234 requires that a data field be opened for an expected downloaded delivery transaction of shares from account 5678 and a receive transaction in account 1234. Upon receipt of the expected downloaded transactions, the transactions may be matched with the open data fields and the fields may be closed and removed from the user's screen.

A similar process may be used for money transfers, such as a wire from account 5678 to account 1234. When an embodiment of the inventions identifies that the wire out of account 5678 is related to the wire into account 1234 such as by matching amounts and dates, a match of the two downloaded wire transactions can be made. The data fields that were created for the expected delivery of funds and reduction in balance from one account, and receipt of funds and corresponding increase in a balance of the other account can fill the data fields that were created by the expected movement of funds, match the two downloaded transactions, and clear the data fields from the user's screen.

If an embodiment of the system determines that a wire transfer was used to pay for shares that are in a specific group ID, the downloaded record of the wire transfer may add the record of the wire to the transaction group in the ledger by assigning it the relevant group ID.

When downloaded transactions are saved to the ledger, the details of the matching or pairing, consisting of the group ID ledger ID of the matched transactions as well as the number of shares involved in the match, are saved to a matching table so that the matched transaction or expected but missing transactions may be evaluated to compare the number of shares in buy and sell transactions in the transaction group to the number of shares matched between the buys and sells in a matching table. When there are more shares in the transaction than shares matched, an embodiment of the system may determine that transaction is still open and may record the open position and issue an alter to the user. The matched delivers and receives may also be used to determine which positions are still undelivered.

In another example, if a buy takes place in account A, the shares could then be delivered to account B. From account B they could be delivered to account C, from account C to account D, etc. Then when they are sold in account E, a final delivery needs to take place from account D to account E. A data field for deliveries and receipts may be opened automatically for each transfer of shares and their expected downloaded transactions. Once downloaded and matched, the fields may be closed out or marked as expected and undelivered. To determine which positions are still undelivered, matching information for the transaction group may be read from the downloaded transactions, and a recursive function may be called that begins with the buy, finds out which delivers are matched to it, and then processes those delivers and determines which delivers (if any) they are matched to which accounts as are expected in the chain of accounts until the sale is completed. An end of the delivers that are found in the transaction record may indicate the account in which the shares are stuck and currently held. If no shares or not enough shares are in the account in which the shares are sold, an undelivered position is detected. An alert signal may be issued if the undelivered position remains until a settlement date is reached for the sale transaction. If a sufficient number of shares are in the account at the settlement date, the alert may be cancelled.

In some embodiments, an order of matching of transactions may be imposed. For example, in some embodiments, in a first step, cancel transactions from a download table may be accepted and matched to downloaded buy or sell orders in the ledger or in the download table, and the buys and sells that match the cancels may be closed out.

In some embodiments, in a second step, downloaded buys may be accepted from a download table into the ledger unless there is an open, i.e., an unmatched sale, for that security in an open positions table.

In some embodiments, in a third step, buys may be accepted from a download table into the ledger if the there is currently an open sell of that security in the open positions table in the same account as the buy (or if both accounts clear DVP through the same account), and match the buy(s) to the sale(s).

If there can be found that a sale and buy have been matched in the blotter, and subsequently the same buy and sell are downloaded, the matches from the blotter are applied to the downloaded transactions, which are then accepted into the ledger.

Sells for which there is currently an open buy of that security in the open positions table in the same account as the sell (or if both accounts clear DVP through the same account), may be accepted in the ledger and matched to the corresponding buy.

For delivers and receives, if the transaction is DVP, and if the exact number of shares purchased was delivered from the account that the shares were purchased in, then the deliver may be accepted into the ledger, and matched to the buy. If a matching receive is found in the download and is dated is within one day of the deliver, accept that and match it to the buy, otherwise, if a delivery is expected from account A to account B (i.e., a sale of shares has occurred in an account other than the one in which they were bought), resulting in an undelivered position, then if a deliver is downloaded from account A that matches the exact number of shares expected to be delivered, and a receive is downloaded (or is already in the ledger) from account B that matches the deliver, if only one such delivery is expected, and one deliver and one receive are downloaded (within one day of each other), or if there are multiple such deliveries expected, and the exact number of delivers and receives have been downloaded that have been expected. Then set the account 2 (counterparty) on all the delivers and receives as that of the others' account, accept them into the ledger, and match them to the appropriate buys.

If multiple delivers are expected, and not all of the deliver/receive pairs have been downloaded, do not accept any of the transactions into the ledger.

If a deliver from A is already in the ledger, and a receive is downloaded from account B that matches the deliver (within one day of the deliver), then set the account 2 on the receive to equal the account of the deliver, accept that receive into the ledger, and match it to the buy that the deliver is matched to.

If two sides of a wire (funds delivery or funds receipt record) with matching amounts are downloaded and have transaction dates within one or a few days of each other such that the dates and amounts are within matching tolerance levels of each other (such as net of fees or other deductions), even if one of such records has already been accepted into the ledger, and there are no other wires with the same or matching amounts during that day, then set the counterparty for such wires as that of the others' account, and accept them into the ledger. In some embodiments, a grouping of a first wire or funds transfer record as being associated with a group ID, may allow the system to associate a second or counterparty funds transfer records with the same group ID. If similar or matching sums appear in numerous or a series of wire transfer records within an allowed date tolerance, then some or all of such records may likewise be associated with such group ID. In some embodiments, one, a pair or a series of wire or funds transfer records may be assigned a group ID number (in such case a wire group ID number), and a search of other downloaded records may be performed to find other records with matching dates and amounts. Once found, such other matching records may be associated with the wire group ID number, as the counterparty of the first record. One or more wire group ID numbers may be associated with a group ID number. In some embodiments, an expected proceeds amount of a sale (or amount owing from a purchase) of a security may serve as a basis upon which to associate the group ID with a wire transfer of such whose amount matches such expected amount, and from there to likewise associate the counterparty of such wire transfer amount with such group ID number. In this way, an association of a first transaction record with a group ID, may allow an association of its counterpart)/transaction such as deliveries, receives or wire transfer records with which it is associated, to also be associated with such group ID.

If the wire transaction dates are within tolerance of matching levels of a buy transaction whose amount matches the wired amount, put the wire transaction record in the same Group ID as the buy by assigning the buy's Group ID to the wire transaction record.

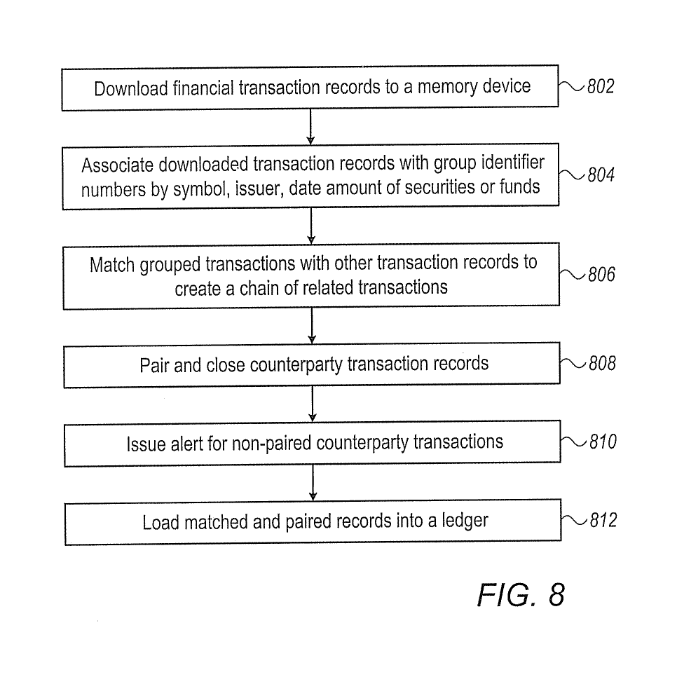

Reference is made to FIG. 8, a flow diagram of a method in accordance with an embodiment of the invention. In some embodiments, in block 802, data in digital form from several or many financial transaction records may be received or downloaded into a memory device. The records may include for example, buy or sell records of securities, transaction cancel records, delivery and receive records of securities, and pay and receipt records of funds (wires). Other records types may also be included. The records may relate to one or many accounts at one or many brokers or financial institutions and to one or many corporate, individual or tax entities.

In block 804, some or all of the downloaded transaction records may be associated or grouped with offering group identifier numbers (ID) that may be generated by a process or a system in accordance with an embodiment of the invention, based on among other things, a symbol or name of the issuer of the securities, a date of the record, an amount of securities or funds in the record or other factors. For example, buy transaction records of an offering of GM stock in March may be assigned or grouped into a GM offering ID number. In block 806, grouped transactions may be matched with one or more other transaction records to create a series or chain of related transactions. For example, one or more buy records of a transaction or offering group may be matched to one or more sell transactions of such offering group. In between such buy and sell transactions, there may be opened one or more deliver and receive fields for transfer of securities between accounts or institutions. For example, if a buy of 1000 GM shares is made in a first account at a first broker, and a sell of 1000 GM shares is made in a second account at a second broker, a delivery and receive must be opened and populated to indicate that the shares were sent from the account where the buy was made to the account where the sell was made. In block 808, certain counterparty transaction records, such as receipt and delivery or securities or wire transfers that usually have only two counterpart records that are relevant to the transaction, may be paired and closed out. Share delivery and receipt transactions may be paired with each other to indicate that the shares were delivered from one account and received in to another. Similarly, one or more wire transfer fields associated with the buy or the sell records may also be opened to show a flow of funds, and paired payment and receipt transactions may be inserted into the fields to show that sent monies from a first account have been received in a second or counterparty account. In block 810, in the event that a pair or counterparty of a share deliver or wire transfer record is not found, an alert signal may be issued and may be sent to a user or displayed on a screen for a user.

In block 812, transaction records that have been grouped, matched and paired may be loaded into a ledger table, and notices or alerts of open positions or unmatched or paired transactions may be presented to a user in for example an alert signal. In some embodiments, data that was inputted, either manually or automatically into one or more allocation tables, blotter tables or other tables may be compared to records that are downloaded, and matching of certain of the downloaded transactions may be facilitated by the links or associations between for example buy and sell transactions as were recorded in such tables and blotters.

In some embodiments, a matching process may include numerous buy transactions and sell transactions, that may be displayed on, for example, a left and a right side of a screen or elsewhere, and a total long or short position of the securities may be shown to a user in real time or at an end of the offering. In between the buy and the sell transactions, or between accounts and brokers, there may appear in a display one or more deliveries and receipts of shares, and/or one or more payments and receipts of funds that may be paired to show that money and shares sent was received.

In some embodiments, the presence of, for example, a sell transaction record relating to a financial account may indicate a date by which shares are to be present or delivered to such account in order to satisfy the obligations of the sell transaction, and the number of shares to be present or delivered by such date. In some embodiments, an alert signal may be presented to a user upon or in advance of a date whereby shares are to be present in account, if such shares are not so present or delivered.

In some embodiments, a presence of for example a buy transaction record in respect of an account may indicate that certain funds must be present or delivered to such account by a date when the purchased shares must be paid for, and the sums of money that must be in the account at such date. In some embodiments, an alert signal may be issued to a user upon or in advance of a date whereby monies are to be present in such account, if such funds are not so present or delivered.

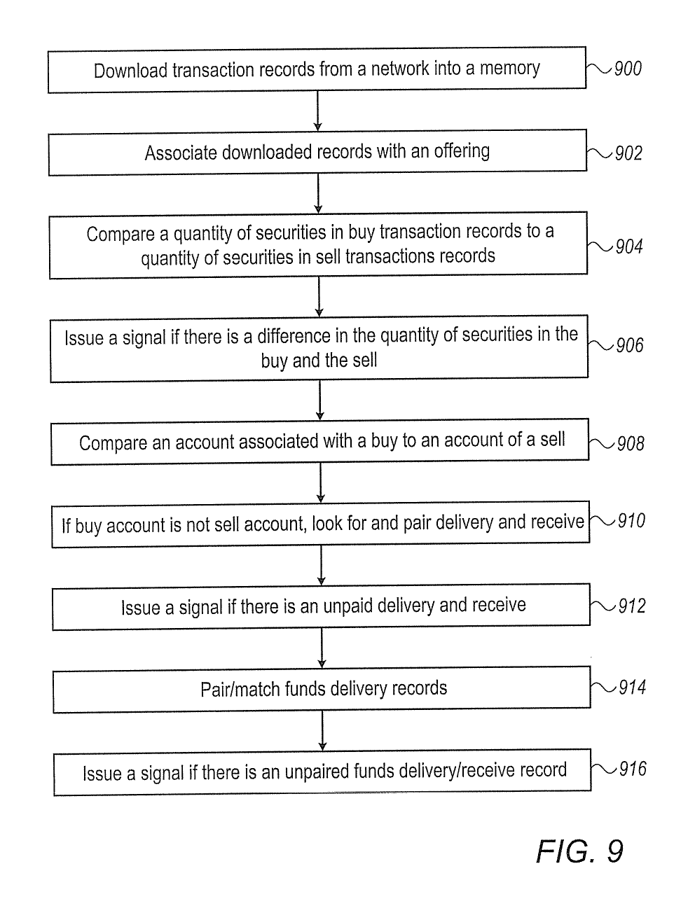

Reference is made to FIG. 9, a flow diagram of a method for reconciling trade, payment and delivery data in financial accounts in accordance with an embodiment of the invention. In block 900, a computing device may download from a network into a memory device data from securities transaction records of from one or more financial accounts that are associated with one or more entities. The downloaded transaction records may include transaction records from one or more different securities offerings that are associated with one more issuers or companies.

In block 902, one or more of such downloaded records may be associated with a first securities offering and one or more other records may be associated with and a second securities offerings. The associations of records with one or another offering may be determined by comparing one or both of a date of the offering and the date of the particular transaction record, and comparing an issuer symbol connected with the offering and an issuer symbol of the transaction record. For example, if a date of an offering is Jan. 1, 2014, and the issuer's symbol of such offering is GM, then a transaction record showing a buy of GM shares on Jan. 2, 2014 would be associated with the offering by way of for example a unique identifier of the offering being associated with the transaction record. However a transaction record of GM dated Mar. 1, 2014 would most likely not be associated with the same offering. In some embodiments, the downloaded transaction records that are associated with a particular offering may be grouped in connection with such offering, for purposes of an embodiment of the invention. Similarly, a record having an issuer identifier of T would not be associated with the GM offering.

In block 904, a comparison may be made by, for example, a processor of a quantity of securities in buy transaction records from among the securities transaction records of the first offering, to a quantity of securities in sell transactions records from the securities transaction records of said first offering in said plurality of financial accounts.

In block 906, a signal or indication may be recorded or presented to a user if there is an indication of a difference in the quantity of securities in the buy transaction records and the sell transaction records of the offering.

In block 908, a processor or some other device may compare an account identity or identifier that is associated with a buy transaction record to an account identity or identifier of a sell transaction records. In block 910, if the comparison indicates that the securities were bought in an account that is different from or not the same as the account in which the securities were sold, such comparison may be deemed an indication that the securities were or need to be delivered from the first account to the second account or to more than one accounts. In such case, an embodiment of the system may select a delivery transaction record from the buy account and a receipt transaction record from the sell account and attempt to match such delivery record of a quantity of securities of the buy transaction records of the first account to a receive record of the same or some other quantity of securities in the sell transaction records of the second accounts. If no such delivery or receive transactions are found, or if the receive and deliver are not paired with a counterparty, an alert may be issued to indicate that the securities have not been delivered or received at the account from which they are to be sold.

In block 912, a signal or alert may be issued if there is at least one of delivery and receive record from associated with said securities offering that are not paired.

In block 914, an embodiment may pair or match a funds delivery record from a securities transaction records from a first account to a funds receive record from a second financial account. Such pairing may be on the basis of one or more of an amount of the delivery and receive records, the date of the delivery and receive records or other factors.

In block 916, a signal or alert may be issued by for example a processor on a screen or display if a funds delivery record and a funds receive record are not paired.

In some embodiments of the invention, the records that are downloaded may be stored in a first data structure such as a data base, before such records are grouped, matched and paired, and then the records may be stored in for example a ledger as grouped, matched and paired. As stored in the ledger, an embodiment may calculate the open positions, missing delivered securities, insufficient funds in particular accounts or other calculations

In some embodiments, a signal may be presented to a user in the event that there is an open position in holdings of a security among all of the accounts, and such signal may be or be accompanied by a quantity of securities represented by the open position.

In some embodiments, if there is a delivery and receive record that are not paired, a signal may be presented to a user of the account associated with the unpaired receive or delivery record.

In some embodiments, a signal may be presented to a user in advance of a date upon which a quantity of securities is due for deposit in or delivery to accounts where the securities should have been, but have not been delivered.

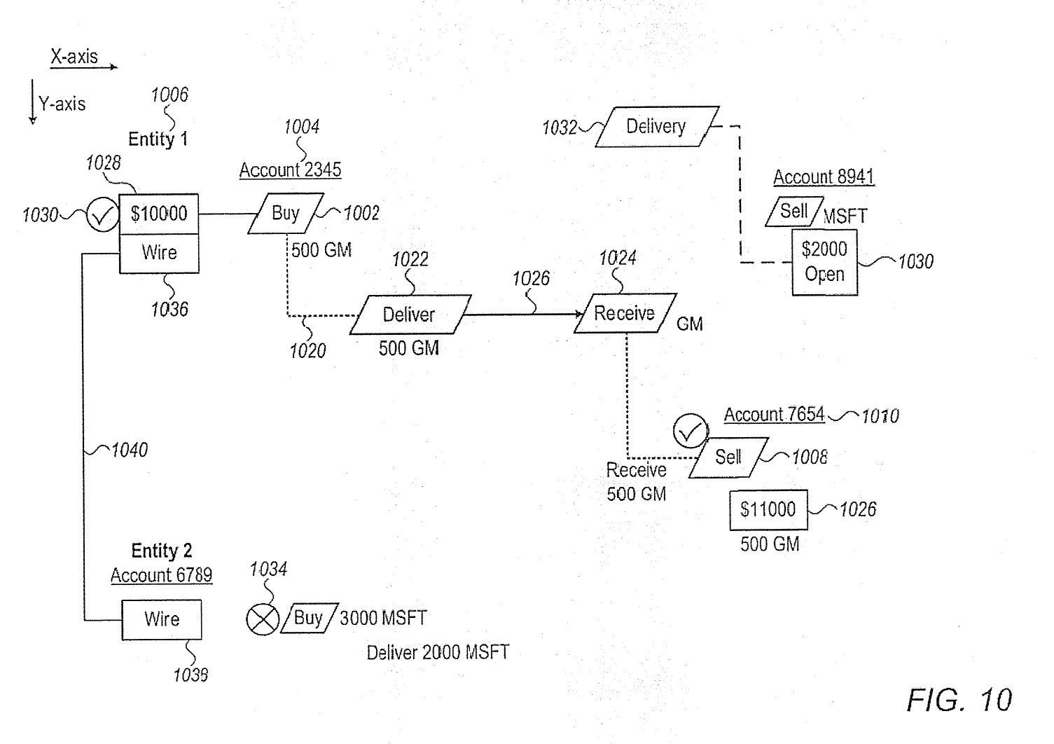

Reference is made to FIG. 10, a method of displaying on a display one or more indications of financial transactions in more than one account, in accordance with an embodiment of the invention.

A display, page or screen may graphically represent on a first axis, such as a vertical axis of the display, a buy transaction 1002 of securities of a first securities offering from a first account 1004 of a first entity 1006, and on a second axis of the display a sell transaction 1008 of securities of the first securities offering from a second account 1010. Other axes, such as horizontal, diagonal, etc. may be used.

In some embodiments, there may be shown on the screen or display in association with the graphical representation of the buy transaction 1002, a number or quantity of securities 1014 that were purchased under the buy transaction and a symbol 1016 or other identifier of issuer of the securities purchased under buy transaction 1002. The association may be shown, for example, inside or near a box or other shape, icon 1018 or colored area on the screen. In some embodiments, some information may be displayed within the icon 1018 or shape while other information, such as a date, entity name of the buyer, broker name of the account, etc., may be displayed when a user clicks or hovers on the representation, icon 1018 or shape.

There may be shown a graphical representation of the 1008 sell transaction, a number of securities of the sell transaction and an issuer identifier of the securities of sell transaction.

There may be shown, displayed or created a graphical representation along a substantially horizontal axis of the display, a connection 1020 of the representation of the buy transaction to a graphical representation of a delivery 1022 of securities of the buy transaction. For example, a line, dashed line, arrow, colored area, or other visible signal of sign may connect the space or icon of the buy transaction with a space, signal or visible representation of the delivery 1024 of the securities that were purchased and held under the buy transaction, to another account. In some embodiments, the delivery 1024 representation may be or include a darkened color or colored line. In some embodiments, a delivery 1024 transaction may be represented by a dashed line until a receive 1024 transaction is received of the delivered securities, whereupon the delivery line or representation may be changed into a full line 1026 or connection. In some embodiments, a delivery or receipt transaction that is not yet matched with a counterparty receipt or delivery transaction may blink or flash on the screen. Other axes or ways to represent or show a delivery and receipt are possible.

In some embodiments, there may be shown a representation along the substantially horizontal axis of the display, a connection of the representation of the sell transaction 1008 to a graphical representation of a receipt 1024 of securities of the sell transaction.

In some embodiments, when the receipt and delivery transactions records are paired, a graphic representation of the completed receipt and delivery may be shown by a visible indication of the pairing of the receipt and delivery.

In some embodiments, there may be shown a sum 1028 or money that needs to be delivered or deposited in connection with the buy transaction 1002, and such stun may be shown near, under, over or otherwise in connection with the displayed buy transaction. In some embodiments, a stun 1026 of money to be received from the sell transaction may be shown or displayed near or in visible with the sell transaction 1008.

In some embodiments, a display or visible sign 1030 (such as a √) of a receipt or delivery of money into an account may be shown in connection with the symbol, sign, representation or indication of the account into which or from which the money was sent or received. In some embodiments, a visible signal may be shown as associated with the buy transaction that money for such buy transaction has been received into the account wherein the buy transaction was executed. Once the record of the received money into the account is paired with a record or other indication of a sum of money delivered to the account, there may be shown a graphical representation of the settlement or receipt of sums into the buying account, to show that a sufficient amount of money has been deposited or received to satisfy the money obligations associated with the account and the buy transaction.

Some embodiments may include showing on the display a visible signal of an open position 1030 associated with at least one of the buy transaction and the sell transaction. For example, an open position may be represented by a blinking, red, bold or other visible warning or listing of the open position.

In some embodiments, a visible representation may be shown if there is one or an unpaired receipt or delivery 1032 of one or more of funds or securities, and a visible signal (such as an X 1034) of the account wherein are insufficient monies are available or held to cover an amount owing to be paid on a buy or other transaction.

In some embodiments, a visible representation of a wire transfer receipt 1036 and wire transfer deliver 1038 may be presented near an account from or to which such wire transfer was sent or received, and a connection of the representation may appear when the two wires are paired.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention. Various embodiments have been presented. Each of these embodiments may of course include features from other embodiments presented, and embodiments not specifically described may include various features described herein.

1. A method for reconciling trade, payment and delivery data in a plurality of financial accounts, comprising
receiving into a memory device, data from a plurality of securities transaction records of said plurality of financial accounts, said plurality of transaction records including transaction records from a plurality of securities offerings;
associating a first of said plurality of records stored in said memory device with a first of said securities offerings and a second of said plurality of records with a second of said securities offerings
by
associating an issuer identifier of said first of said plurality of records with an issuer identifier of said first offering and by associating a proximity of a date of said first of said plurality of records with a date of said first offering, and
associating an issuer identifier of said second of said plurality of records with an issuer identifier of said second offering and by associating a proximity of a date of said second of said plurality of records with a date of said second offering;
comparing
a quantity of securities in buy transaction records from among said plurality of securities transaction records of said first offering
to
a quantity of securities in sell transactions records from among said plurality of securities transaction records of said first offering in said plurality of financial accounts, and
indicating an open position if said comparison indicates a difference in said quantity of securities in said buy transaction records and said sell transaction records;
comparing an account identity of a first of said buy transaction records to an account identity of a first of said sell transaction records, and
if said account identities are not the same,
pairing a delivery record of a quantity of securities of a first of said buy transaction records, said delivery from a first of said plurality of financial accounts
to a receive record of said quantity of securities of a first of said sell transaction records, said receive record from a second of said plurality of financial accounts; and
issuing a first signal if there is at least one of a delivery and receive record from said plurality of records associated with said first securities offering that are not paired; and
pairing a funds delivery record from among said plurality of securities transaction records stored in said memory device, said funds delivered record from a first of said plurality of financial accounts
to a funds receive record from among said plurality of securities transactions records, said funds received records from a second of said plurality of financial accounts; and
issuing a second signal if there is at least one of said funds delivery and said funds receive record from said plurality of records associated with said first securities offering that is not paired.

2. The method as in claim 1, wherein said receiving into a memory device comprises storing said plurality of securities transaction records in a first data structure, and comprising storing an indication of said paired funds delivery and said funds receive record in a second data structure.

3. The method as in claim 1, wherein said receiving into a memory device comprises storing said plurality of securities transaction records in a first data structure, and comprising storing an indication of said paired securities delivery and securities receive record in a second data structure.

4. The method as in claim 1, wherein said indicating an open position, comprises including in said indication of said open position a quantity of said securities of said first offering represented by said open position.

5. The method as in claim 1, wherein said issuing said first signal if there is at least one of a delivery and receive record that are not paired, comprises indicating an account from among said plurality of financial accounts associated with said not paired receive or delivery record.

6. The method as in claim 1, wherein issuing said second signal comprises issuing said second signal in advance of a date upon which said quantity of securities is due for deposit in said second of said plurality of financial accounts.

7. A method of displaying on a display financial transactions in a plurality of accounts, comprising:
graphically representing, on a first vertical axis of said display, a buy transaction of securities of a first securities offering, and on a second vertical axis of said display a sell transaction of securities of said first securities offering;
showing in association with said graphical representation of said buy transaction, a number of securities of said buy transaction and an issuer identifier of said securities of said buy transaction;
showing in association with said graphical representation of said sell transaction, a number of securities of said sell transaction and an issuer identifier of said securities of said sell transaction;
graphically representing along a substantially horizontal axis of said display, a connection of said representation of said buy transaction to a graphical representation of a delivery of securities of said buy transaction;
graphically representing along said substantially horizontal axis of said display, a connection of said representation of said sell transaction to a graphical representation of a receipt of securities of said sell transaction; and
graphically representing, upon a pairing of a transaction record of said delivery of securities with a transaction record of said receipt of securities, a display of a connection of said delivery of securities to said receipt of securities.

8. The method as in claim 7, comprising:
showing in association with said displayed buy transaction an amount of money to be delivered in connection with said buy transaction; and
showing in association with said displayed sell transaction, an amount of money to be received in connection with said sell transaction.

9. The method as in claim 7, comprising
showing in association with said represented buy transaction an indication of a sum of money received into a first financial account wherein said buy transaction was executed; and
upon pairing of a record of said money received into said first financial account with a record of said sum of money delivered from a second financial account, graphically representing said first account, said second account, and a representation of a connection of said representation of first account to said representation of said second account.

10. The method as in claim 7, comprising showing on said display a visible signal of an open position associated with at least one of said buy transaction and said sell transaction.

11. The method as in claim 7, comprising showing on said display a visible signal if at least one of said graphical representation of said receipt of securities is unpaired to at least one graphical representation of said delivery of securities.

12. The method as in claim 7, comprising showing on said display a visible signal of a financial account wherein are held insufficient monies to cover an amount owing to be paid from a financial account wherein was executed said buy transaction.

13. A system to associate, match and pair financial transaction records, the system comprising:
a processor, a memory, and a display;
wherein said memory stores in a first data structure a plurality of financial transaction records of a plurality of financial accounts, and stores in a second data structure said plurality of financial transaction records as matched and paired records
wherein said processor:
associates each of a set of said financial transaction records with a unique identifier of an offering by comparing a date and issuer symbol of said offering with a date and issuer symbol of said each of said first set of financial transactions;
matches buy transaction records associated with said offering with sell transaction records associated with said offering;
issues an alert on said display if a number of securities bought in said buy transaction records is not equal to a number of securities sold in said sell transaction records;
pairs each of a delivery transaction record associated with said offering to a receive transaction record associated with said offering;
issues an alert on said display if at least one of said delivery transactions is not paired to at least one of said receive transaction records;
pairs each of a funds deliver records from said set of financial transaction records with a funds receive record from said set of financial transaction records;
issues an alert on said display if at least one of said funds deliver records is not paired with at least one of said funds receive record; and
issues a signal to store each of said matched and paired records in said second data structure.

14. The system as in claim 13, wherein said processor issues an alert if a funds balance in at least one said accounts is insufficient to cover a sum of money required to cover an obligation of at least one of said buy transaction records.

15. The system as in claim 13, wherein said processor issues a signal to show on said display a representation of a first of said accounts that is associated with said delivery transaction record associated with said offering, and a second of said accounts that is associated with said receive transaction record associated with said offering.

16. The system as in claim 13, wherein said processor issues a signal to show on said display a representation of said pairing between said first of said accounts and said second of said accounts, of said delivery transaction record associated with said offering and said receive transaction associated with said offering.
